(19) United States
(12) Patent Application Publication
(10) Pub. No.: US 2019/0013915 A1
(43) Pub. Date: Jan. 10, 2019

(54) NR ABSOLUTE SYNC FREQUENCY ALLOCATIONS

(71) Applicant: Telefonaktiebolaget LM Ericsson (publ), Stockholm (SE)

(72) Inventors: Magnus Åström, Lund (SE); Bengt Lindoff, Bjärred (SE); Pål Frenger, Linköping (SE); Claes Tidestav, Bålsta (SE)

(21) Appl. No.: 15/736,670

(22) PCT Filed: Oct. 31, 2017
(86) PCT No.: PCT/EP2017/077883

§ 371 Date: Dec. 14, 2017

Related U.S. Application Data
(60) Provisional application No. 62/442,705, filed on Jan. 5, 2017.
(60) Provisional application No. 62/417,753, filed on Nov. 4, 2016.

(51) Int. Cl. H04L 5/00; H04W 48/16; H04W 56/00; H04W 72/10

(52) U.S. Cl. CPC H04L 5/0051; H04W 48/16; H04W 72/0453; H04W 72/10; H04W 56/001

(57) ABSTRACT

A method of a network node for distributing a sync signal is disclosed. The network node is operating in a carrier band within a cellular band. The method comprises determining, from a predefined sync frequency set for the cellular band, a sync frequency location that is within the carrier band. The predefined sync frequency set comprises a plurality of sync frequency locations that are allowable for the cellular band. The method further comprises configuring a sync signal to be transmitted on the determined sync frequency location and transmitting the sync signal on the determined sync frequency location. A method of a wireless communication device is also disclosed. The method comprises determining a sync frequency location from a predefined sync frequency set for a cellular band. The cellular band comprises multiple carrier bands. Further, the method comprises attempting to receive a sync signal on the determined sync frequency.

### TECHNICAL FIELD

The present disclosure relates to synchronization in a cellular communications system and, in particular, synchronization (sync) frequency allocation in a cellular communications system.

### BACKGROUND

Initial Access (IA) is the process of powering on a wireless device such as a User Equipment device (UE) in order for it to access the cellular network. There are three steps in this procedure, which are fairly independent of which Radio Access Technology (RAT) that is being used (the below is inspired by Long Term Evolution (LTE)):
1. Cell search—acquiring network symbol and frequency synchronization (sync) to the network and obtaining fundamental cell information, e.g., the cell Identity (ID), for cell selection.
2. Receiving system information—receiving further cell and network information defining cell and network properties, e.g., operator, carrier bandwidth, system frame number, access information, and adjacent cell information.
3. Random access procedure—this is the step where the UE signals its presence to the network in order for the network to be able to page or schedule the UE.

In order to transmit and receive signals at a specific carrier frequency, a transceiver (both base station and device) needs to translate a baseband signal to/from the carrier frequency. This is done by mixing a signal with a local version of the carrier frequency generated in the local oscillator (LO). A LO, in turn, derives its output signal from a crystal oscillator (XO) from which a signal with a fundamental frequency is up-converted or modulated to the desired carrier frequency. The open loop (i.e., prior to the LO having locked to the carrier frequency) relative frequency inaccuracy in a crystal is typically 10-50 parts per million (ppm) depending on the XO frequency and quality. Typically, the higher carrier frequency, in order to cope with the phase noise, an XO with higher resonance frequency is needed, and the higher reference frequency for the XO, the higher is also the relative inaccuracy implying that higher New Radio (NR) carrier frequencies will face a fivefold relative frequency inaccuracy compared to LTE at 2-3 gigahertz (GHz). NR is the term used to refer to Third Generation Partnership Project (3GPP) Fifth Generation (5G) NR.

LTE comprises two synchronization signals, the Primary Synchronization Signal (PSS) and the Secondary Synchronization Signal (SSS), respectively, that are used in order to establish symbol and frequency sync and to obtain, e.g., cell ID. The PSS is used in order to get an initial frequency lock (±4 kilohertz (kHz)) which is further refined in the SSS.

In order to identify prospect sync frequencies, the UE may in some prior art solutions perform a frequency scan over the complete frequency band in order to obtain a power spectrum estimate, as illustrated in FIG. 1. From the frequency scan, the UE may obtain the individual frequency carriers from a matched filtering operation in which the LTE spectrum shape is used, typically one shape for each LTE bandwidth, as illustrated in FIG. 2. FIG. 2 illustrates results of a matched filtering operation for the frequency scan of FIG. 1. This gives the UE an initial understanding of what carrier bandwidths are present in the frequency band and where, and consequently, at what frequencies to search for PSS and SSS since their positions are fixed in the time-frequency grid, as illustrated in FIG. 3. FIG. 3 illustrates frequency locations to be searched for synchronization signals based on the results of the matched filer operation of FIG. 2. Notably, FIG. 3 is a simplification in that multiple frequencies are typically tested around each peak.

The above identified cell search positions are quite inaccurate though. Furthermore, a simple spectrum analysis does not take into account the possible frequency error that may be present in the UE. Hence, for each identified position, and possibly also adjacent alternative frequencies, there is a need to manage the large initial frequency errors that may be expected at power on, typically up to ±30 kHz at a carrier frequency of 2.6 GHz. This is done by a grid search in which different frequency error hypotheses are tested in order to identify the most likely one, i.e., the frequency error for which the likelihood of an existing PSS is maximized. Having done that, the UE may continue its cell search procedure by receiving the SSS.

### SUMMARY

The present disclosure relates to methods and devices for distributing a synchronization (sync) signal and for performing synchronization to a wireless communications network.

A method is disclosed for allocating carrier sync frequency locations within a cellular frequency band. By allocating fixed sync frequency locations within a certain cellular band, e.g., Band 1, the frequency search grid is significantly reduced, hence, also reducing initial access time.

Further, a device method is disclosed for fast initial access in a system where sync signals transmitted from cells/antenna beams are transmitted on at least one of a set of fixed carrier sync frequency locations (fixed regardless of cell/beam system bandwidth). By allocating fixed sync frequency locations within a certain cellular band, e.g., Band 1, the frequency search grid is significantly reduced, hence, also reducing initial access time. According to a first aspect, a method of a network node for distributing a sync signal, is disclosed. The network node is operating in a carrier band within a cellular band. The method comprises determining, from a predefined sync frequency set for the cellular band, a sync frequency location that is within the carrier band. The predefined sync frequency set comprises a plurality of sync frequency locations that are allowable for the cellular band. The method further comprises configuring a sync signal to be transmitted on the determined sync frequency location and transmitting the sync signal on the determined sync frequency location.

According to a second aspect, a method of a wireless communication device for performing synchronization to a wireless communications network is disclosed. The method comprises determining a sync frequency location from a predefined sync frequency set for a cellular band. The cellular band comprises multiple carrier bands. Further, the method comprises attempting to receive a sync signal on the determined sync frequency.

According to a third aspect, a network node adapted to distribute a sync signal according to the method of the first aspect, is disclosed.

According to a fourth aspect, a wireless communication device adapted to perform synchronization to a wireless communications network according to the method of the second aspect, is disclosed.

One advantage of the present disclosure is a shortened time for the UE to make initial access to a network. This reduction in total UE search time is obtained by allowing the UE to search in fewer frequency locations. The total search time is the combination of the search time per frequency and the total number of frequency locations. Consequently, the time the UE needs to determine that a certain frequency location is not used (sometimes denoted the UE dwell time) can be extended in case the number of frequency location candidates is reduced. This can be used to enable longer network Discontinuous Transmission (DTX) operation which results in lower network energy consumption and reduced downlink interference as further advantages.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is an illustration of a frequency scan over a complete, cellular band;

FIG. 2 illustrates results of a matched filtering operation for the frequency scan of FIG. 1;

FIG. 3 illustrates frequency locations to be searched for synchronization (sync) signals based on the results of the matched filtering operation of FIG. 2;

FIG. 4 illustrates one example of a cellular communications system in which embodiments of the present disclosure may be implemented;

FIG. 5 presents a flow chart that illustrates the operation of a network node (e.g., a radio access node) according to some embodiments of the present disclosure;

FIG. 6 illustrates an example of a fixed raster distance resulting in a too wide cropped tree relative to the frequency band according to some embodiments of the present disclosure;

FIG. 7 illustrates an example of a fixed raster distance resulting in too narrow trees, requiring dual overlapping trees relative to the frequency band according to some embodiments of the present disclosure;

FIG. 8 illustrates an example of sync allocation based on the search tree approach, presenting all sync frequency locations resulting from a four level tree search;

FIG. 9 presents a flow chart that illustrates a method of operation of a device (e.g., a User Equipment device (UE)) according to some embodiments of the present disclosure;

FIG. 10 illustrates an extension of the process of FIG. 9 according to some embodiments of the present disclosure;

FIG. 11a is an illustration of sync allocation based on the search tree approach, presenting all sync frequency locations resulting from a four level tree search, according to some embodiments of the present disclosure;

FIG. 11b is an illustration of sync allocation based on the search tree approach according to some embodiments of the present disclosure;

FIG. 12 illustrates one example of an embodiment in which sync frequency locations are at or near the edges of the carrier bands according to some embodiments of the present disclosure;

FIG. 13 is a flow chart that illustrates the operation of a network node (e.g., a radio access node) according to some embodiments of the present disclosure;

FIG. 14 is a flow chart that illustrates the operation of a device (e.g., a UE) according to some embodiments of the present disclosure;

FIGS. 15 and 16 illustrate example embodiments of a wireless communication device; and

FIGS. 17 through 19 illustrate example embodiments of a network node.

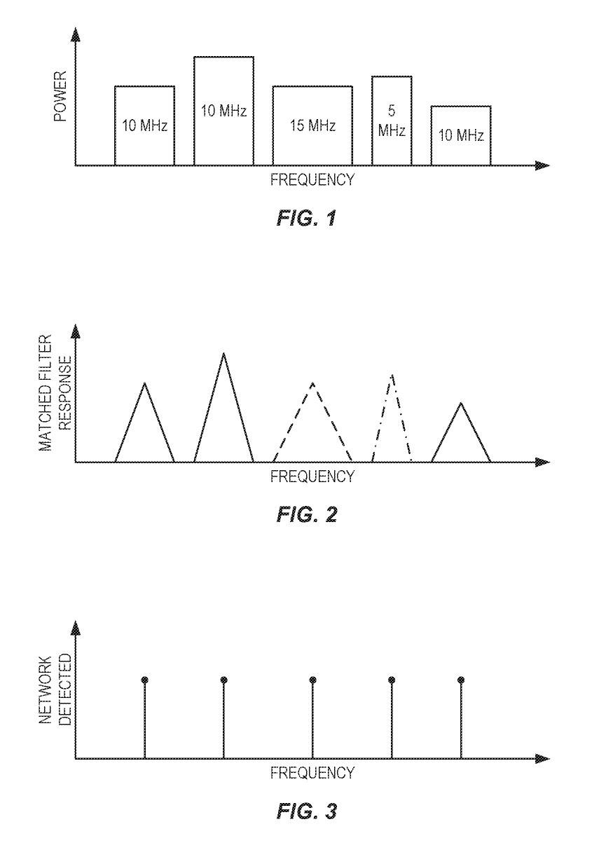

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless device.

Radio Access Node: As used herein, a “radio access node” is any node in a radio access network of a cellular communications network that operates to wirelessly transmit and/or receive signals. Some examples of a radio access node include, but are not limited to, a base station (e.g., an enhanced or evolved Node B (eNB) in a Third Generation Partnership Project (3GPP) Long Term Evolution (LTE) network), a g Node B (gNB) in a 3GPP New Radio (NR) network, a high-power or macro base station, a low-power base station (e.g., a micro base station, a pico base station, a home eNB, or the like), and a relay node.

Core Network Node: As used herein, a “core network node” is any type of node in a core network. Some examples of a core network node include, e.g., a Mobility Management Entity (MME), a Packet Data Network (PDN) Gateway (P-GW), a Service Capability Exposure Function (SCEF), or the like.

Wireless Device: As used herein, a “wireless device” is any type of device that has access to (i.e., is served by) a cellular communications network by wirelessly transmitting and/or receiving signals to a radio access node(s). Some examples of a wireless device include, but are not limited to, a User Equipment device (UE) in a 3GPP network and a Machine Type Communication (MTC) device.

Network Node: As used herein, a “network node” is any node that is either part of the radio access network or the core network of a cellular communications network/system.

Cellular Band: As used herein, a “cellular band” is a total frequency band allocated for a cellular Radio Access Technology (RAT). As an example, LTE Band 7 at 2.6 gigahertz (GHz), which is the frequency band from 2620-2690 megahertz (MHz)) is a cellular band. Typically, multiple carrier bands are implemented within a cellular band. Note that a “cellular band” is also referred to herein as a “RAT band.”

Carrier Band: As used herein, a “carrier band” is a frequency band allocated to a particular carrier within a cellular band. For example, multiple carriers may be implemented within a single cellular band, where each carrier has a respective carrier band within the cellular band. As an example, multiple LTE carriers, each having its own respective carrier band, may be implemented within LTE Band 7. Note that a “carrier band” may also be referred to herein as a “network band,” a “system band,” a “system bandwidth” or a “network node system bandwidth.”

Synchronization (sync) Frequency Location: As used herein, a sync frequency location is a frequency band in which a sync signal is transmitted. For example, a sync frequency location may be a 5 MHz frequency band within a carrier band, where the corresponding sync signal is transmitted within that 5 MHz frequency band. A sync frequency location may be defined in any suitable manner such as, for example, a center frequency and bandwidth, an edge frequency and a bandwidth, or two edge frequencies (i.e., the lower and upper frequencies defining the sync frequency location). Note that a sync frequency location may also be referred to herein as a sync frequency position.

Note that the description given herein focuses on a 3GPP cellular communications system and, as such, 3GPP LTE terminology or terminology similar to 3GPP LTE terminology is oftentimes used. However, the concepts disclosed herein are not limited to LTE or a 3GPP system.

Note that, in the description herein, reference may be made to the term “cell;” however, particularly with respect to Fifth Generation (5G) concepts, beams may be used instead of cells and, as such, it is important to note that the concepts described herein are equally applicable to both cells and beams.

In Long Term Evolution (LTE), synchronization (sync) is based on, e.g., spectral waveform recognition. This is done by first recording the spectrum and then applying a matched filter, in order to identify viable LTE carrier bands and their center frequency. In order to obtain a sufficiently good spectrum, the signal needs to be averaged over some time, e.g., 100 milliseconds (ms).

The 5th Generation (5G) New Radio (NR) cellular systems will be applied on frequencies up to 100 gigahertz (GHz) in several cases with GHz wide frequency bands. This will result in a huge search grid in order to identify the sync signal, making sync all but impossible to manage in limited time. First and foremost, in a lean Radio Access Technology (RAT), such as NR, sync signals may be transmitted as rarely as once every 100 ms and signals being transmitted on a need basis only, implying the above mentioned LTE approach to become highly inefficient.

Hence, a wireless device or a User Equipment device (UE) cannot per default expect there to be any spectrum to detect, but only when the need arises from another UE communicating with the 5G NR base station, which is referred to as a gNodeB or gNB. Secondly, should there be an existing power spectrum, the sync signal will be transmitted so infrequently that spectrum estimation averaging would be far too time consuming to be feasible. Consequently, initial access would be an arbitrarily long process which is clearly an undesired property. Hence, there is a need for a new procedure for performing initial access in order to improve user experience.

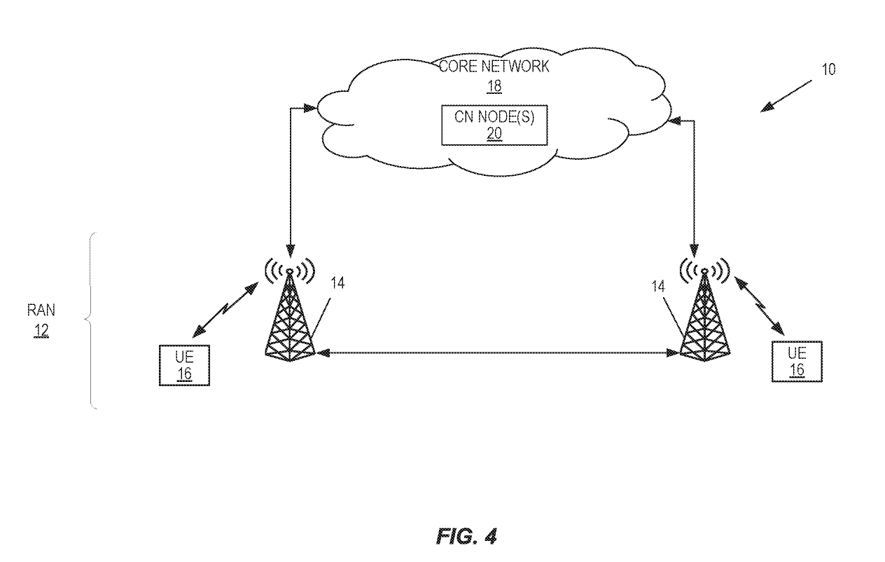

FIG. 4 illustrates one example of a cellular communications system 10 in which embodiments of the present disclosure may be implemented. As illustrated, the cellular communications system 10 includes a Radio Access Network (RAN) 12 that includes a number of radio access nodes 14 (e.g., base stations such as, e.g., 5G NR base stations (referred to as gNBs)). In some embodiments, the RAN 12 is a 5G NR RAN and the radio access nodes 14 are gNBs, where gNB is a term used to refer to 5G NR base stations. The radio access nodes 14 provide wireless, or radio, access to UEs 16 via corresponding cells or beams. The radio access nodes 14 are connected to a core network 18. The core network 18 includes one or more core network nodes 20 such as, for example, Mobility Management Entities (MMEs), Serving Gateways (S-GWs), Packet Data Network Gateways (P-GWs), and/or the like.

The present disclosure relates to allocating and transmitting sync signals in a wireless network that is allocated in a frequency band together with other wireless networks. More specifically, the present disclosure relates to allocating and transmitting sync signals in a cellular communications system in which multiple carriers are implemented within the same cellular band. Further, there may be multiple cellular bands. In some embodiments, at least some of the different carriers are operated by different network operators and, as such, are part of different cellular networks.

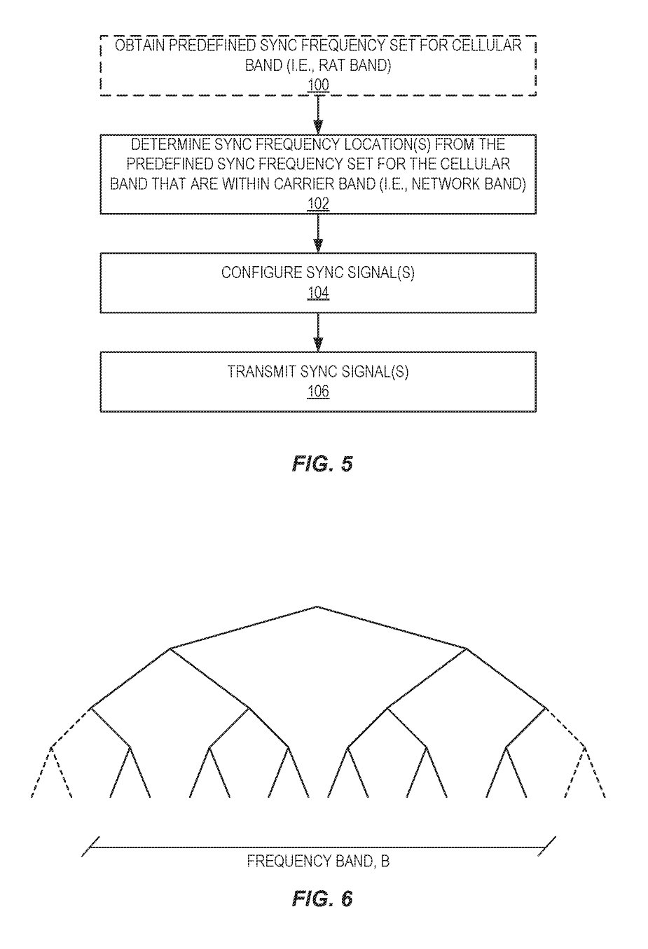

FIG. 5 presents a flow chart that illustrates the operation of a network node (e.g., a radio access node 14) according to some embodiments of the present disclosure. As illustrated, the network node starts by obtaining a predefined sync frequency set for a cellular band (step 100). Note that step 100 is optional (i.e., may not be performed in all implementations). The predefined sync frequency set consists of multiple sync frequency locations that are allowed for sync signal transmission for the cellular band. Examples of the cellular band include, but are not limited to, 3GPP Bands 1, 7, etc. The sync frequency set may be predefined, e.g., by standard. Further, the sync frequency set may be predefined as a list of allowed sync frequency locations or by a mathematical formula, for example. Thus, obtaining the predefined sync frequency set may be done by either reading a table (e.g., a table that is based on the standard defined allowed sync signal frequency locations) from memory, retrieving the predefined sync frequency set from a central node (e.g., a core network node 20), or deriving the sync frequency set from a mathematical formula (e.g., a mathematical formula defined by a standard). Furthermore, in some embodiments, the sync frequency locations may also be a function of the NR carrier spacing to use, i.e., different subcarrier spacings may have different allowed sync frequency locations (or sync signal bandwidths). In, e.g., the latter case, a tree search algorithm is one option in which the set of allowed sync frequency locations are iteratively computed from a binary search tree.

The network node determines one or more sync frequency locations to use from the predefined sync frequency set (step 102). In other words, for a particular carrier band, the network node determines one or more sync frequency locations from the predefined sync frequency set that are within the carrier band. In some embodiments, this may be done by selecting any sync frequency location from a list of sync frequency locations in the predefined sync frequency set that falls within the carrier band, e.g., selecting the central most sync frequency location from the list, or selecting the first sync frequency location in the list that is within the carrier band.

In some other embodiments, the network node determines the sync frequency location(s) to use by using an iterative search as will be further discussed below. For example, a hierarchical tree search algorithm is one option in which the sync frequency locations in the sync frequency set are iteratively computed from a binary search tree until a sync frequency location that is comprised within the carrier band is found. In other words, in some embodiments, the predefined sync frequency set is computed (e.g., using the formula below) and searched as the sync frequency locations in the set are computed using a binary search tree. In this regard, a top-down approach of a sync raster design will now be described. Using LTE Band 7 at 2.6 GHz (2620-2690 MHz) with a bandwidth B=70 MHz as an example, the center frequency of that band may be used as a sync starting frequency. i.e., f(0)=2655 MHz. Note that this starting frequency corresponding to a respective sync frequency location has a defined bandwidth and, e.g., a center frequency at, in this example, 2655 MHz. If the identified sync frequency location is determined to be outside of the carrier band, the search may continue for other sync locations according the following iterative algorithm:

$$f ( k ) = [ \begin{matrix}f ( k - 1 ) - \frac{B}{{2}^{k + 1}} & f ( k - 1 ) + \frac{B}{{2}^{k + 1}}\end{matrix} ]$$

The algorithm is executed by incrementing the index k until a sync frequency location is found that lies within the carrier frequency band. The index k represents the present level or depth of the search tree. It is possible to prune the tree by realizing that a parent node being located on one side of the carrier frequency band and child nodes located even further to that side will also be located outside the carrier frequency band. For example, if f(0) is smaller than the lowest frequency in the carrier frequency band, then any frequency resulting from subtracting the B/2^{k+1} term will also be outside the carrier frequency band. Furthermore, the selected numerology (e.g. subcarrier spacing, symbol duration etc.) of the system or band may affect the selection of which table to use or which mathematical formula to use when computing the sync.

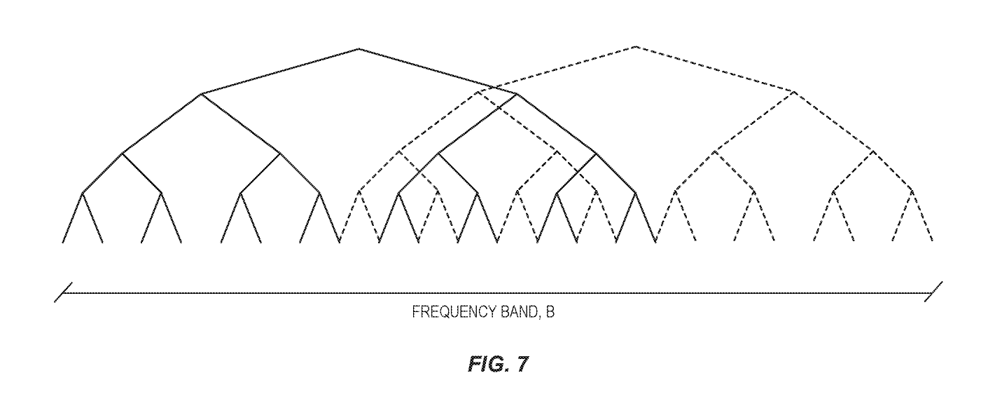

As an alternative to such a top down approach, assuming instead that a fixed sync raster is defined (i.e., fixed sync frequency locations are predefined, e.g., by a standard specification), it is possible to construct a tree in order to determine the prioritized sync frequency locations. For instance, the predefined set of sync frequencies obtained in step 100 may be a fixed set of sync frequency locations. Then, in step 102 of FIG. 5, a tree(s) is constructed from the fixed set of sync frequency locations to provide an efficient mechanism by which the fixed set of sync frequency locations are searched to determine the sync frequency location(s) to use. However, in this case the number of sync raster points (i.e., the number of sync frequency locations) will likely not be even powers of two (less one). It is still possible to design a tree that is not entirely aligned with the frequency band. The solution to this problem is to either construct a too large tree, as is illustrated by FIG. 6, or to construct two too small trees that will partly overlap, as is illustrated by FIG. 7. These trees may then be used, e.g., in step 102 when determining the sync frequency location(s) to use.

The large tree (FIG. 6) or the two small, overlapping trees (FIG. 7) may be constructed from a fixed raster frequency distance, fᵣ, such that the number of raster points, nᵣ, for a given bandwidth B is

$${n}_{r} = ⌊ \frac{B}{{f}_{r}} ⌋$$

where └⋅┘ denotes the floor rounding operation. The fixed raster frequency distance, fᵣ, is the fixed distance between adjacent sync frequency locations, and the number of raster points corresponds to the number of sync frequency locations within the given bandwidth B. For the too wide, or cropped, tree alternative (FIG. 6), a modified (too wide) frequency bandwidth may be defined as

\tilde{B}=fᵣ2^{┌ log}^{₂} ⁿ^{ᵣ}^{┐}

where ┌⋅┐ denotes the ceiling rounding operation. The starting point, f(0), of the tree should still be calculated as the center of the band,

$$f ( 0 ) = \frac{B}{2}$$

whereas the corresponding modified (too narrow) tree bandwidth (FIG. 7) is defined as

\tilde{B}=fᵣ2^{└ log}^{₂} ⁿ^{ᵣ}^{┘}

where the starting points of the two trees, respectively, may be calculated as

$${f}_{1} ( 0 ) = \frac{\tilde{B}}{2} {f}_{2} ( 0 ) = B - \frac{\tilde{B}}{2}$$

Note that the equations above for both the large tree (FIG. 6), which may also be referred to as a “cropped tree solution”, and the two narrower trees (FIG. 7), which may also be referred to as a “dual tree solution”, assume that the number of raster points and the frequency bandwidth (and half bandwidth) break even. In other words, it is assumed that the starting point(s) of the tree(s) are exactly equal to the respective sync frequency location(s). However, in some embodiments, this assumption may not be true. As such, in some embodiments, an error correction or frequency offset is applied to the tree(s) to align them with the desired sync frequency locations. Also, it should be noted that the equations above are only examples. The tree(s) may be constructed in other manners and/or the starting point(s) for the tree(s) may be defined in other manners, depending on the particular implementation.

Having determined the tree starting points, the order of the tree search follows as previously described with some exceptions. In the cropped tree search (FIG. 6), it is necessary to perform a check as to whether the computed tree point is outside or within the bandwidth B. In the dual tree case (FIG. 7), no such risk exists, but instead the priority of the two trees needs to be managed. The priority of the two trees may be managed in any suitable manner. For example, one of the two trees may always be given higher priority than the other tree such that the higher priority tree is searched first. Alternatively, the search may switch back and forth between the two trees such that, e.g., the starting point of a first tree is searched first, then the starting point of the second tree is searched second, then a next position in the first tree is search third, then a next position in the second tree is search fourth, and so on. However, this is only an example. Any suitable technique may be used to search the two trees based on priorities or otherwise.

Also, in an iterative search case such as the tree search case, the sync frequency location with the lowest iteration number may be preferred in order to speed up sync detection for wireless devices or UEs. Other constraints may be attached to this decision, such that the sync frequency location should be within a certain sub-band of the carrier band (e.g., the middle third of the band). Additionally, the node may select multiple sync frequency locations in order to support multiple, from a device perspective, independent sub-bands for devices with different capabilities, e.g., Narrowband Internet of Things (NB-IoT) devices. This may be achieved by e.g. using a certain sync distance or level (e.g. k=5), from a certain level in the result of the iterative tree search. Alternatively, Ultra-Reliable Low Latency Communication (URLLC) devices, for which a specific sub-band within the carrier band may be reserved, may also be allocated a reserved sync frequency location. In that case the sync or an additional sync frequency location may be located within such a sub-band in the carrier band. Furthermore, the determined frequencies (e.g., center frequencies of the sync frequency locations) may be rounded, truncated, or similarly altered to its nearest evolved Universal Terrestrial Radio Access (E-UTRA) Absolute Radio Frequency Channel Number (EARFCN) (or other future defined NR frequency channel number).

Returning to FIG. 5, when the desired sync frequency location(s) is determined, the network node configures a sync signal(s) to be transmitted at the determined sync frequency location(s) (step 104). This implies that the network node must allocate resource blocks and resource elements to the sync signal in order to transmit it in the right time-frequency resource. Since the sync signal is periodically repetitive, this allocation will be repeated periodically with, e.g., an 80 millisecond (ms) period. Furthermore, data of the sync signal may be computed according to a mathematical formula, or read from a data storage, or accessed from a central node prior to being modulated onto the resource elements. In a beamforming environment, the sync signal may be allocated periodically on each antenna beam, such that the above periodicity is an intra-beam periodicity which is then repeated for each antenna beam.

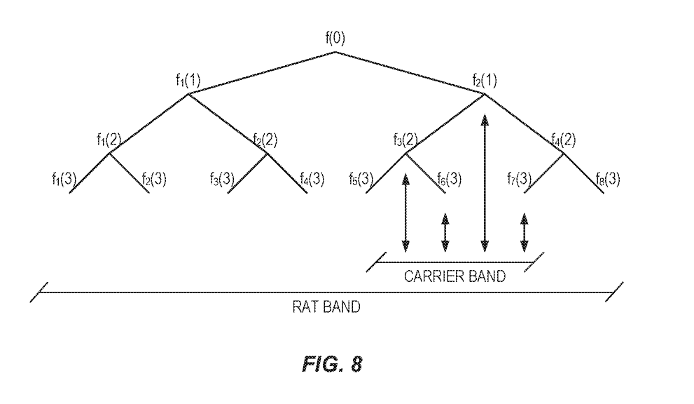

Finally, the network node transmits the sync signal to the UE 16 (step 106), a procedure that is well known in the art. An example of sync allocation based on the tree search approach, presenting all sync frequency locations resulting from a four-level tree search, is shown in FIG. 8. The network node knows its carrier band and must consequently identify a sync frequency location within that band. By starting at the center frequency, the network node may determine that f(0) is outside the carrier frequency band. It may also determine that all frequencies less than f(0) will be outside the carrier frequency band. Continuing with the first level of the iteration, the network node computes the vector f(1) comprising f₁(1) and f₂(1). Even though the node could continue computing more tree levels, it may now choose to stop since f₂ (1) is located within the carrier frequency band of the network node. Furthermore, the network node may determine that selecting f₂(1) is preferable from a UE perspective, provided the UE utilizes the same search tree algorithm, in which case selecting f₂(1) will result in an efficient search. Hence, although f₃(2), f₆(3), and f₇(3) may also be allowed sync frequency locations, the network node may select f₂(1) in order to minimize the corresponding UE search tree.

Further embodiments, related to edge carrier frequency bands, i.e., carriers located at the edge of the band, may include placing the sync frequency location at the edge-most location among a selection of sync frequency locations. The reason for this is that such a location will be valid for arbitrarily wide carrier frequency bands, i.e., one search would include e.g., 20, 40, 60, 100 MHz carrier bandwidths. This is desirable since, e.g., it eliminates one dimension (i.e., bandwidth) from the search space.

Embodiments relating to the operation of the device or UE 16 are also disclosed. More specifically, embodiments relating to a method in a device or UE 16 are disclosed wherein the device or UE 16 attempts to access a cellular network operating in a carrier band, where the cellular network is transmitting sync signals on one of a predefined set of possible sync frequency locations for the cellular band that falls within the carrier band as described above. The network node (e.g., the radio access node 14) that is transmitting the sync signals is operating in a cellular band (e.g., 3GPP frequency band 7) together with other wireless networks. The synchronization signals may be associated to a cell Identity (ID) or beam ID and are transmitted on at least one fixed carrier sync frequency (regardless of cell/beam system bandwidth) and the cell ID/beam ID may be operating in a frequency band shared with other networks. Specifically, the network node that is transmitting the sync signals is operating in a carrier band within the cellular band, where other network nodes may be operating in other carrier bands within the same cellular band, as described above.

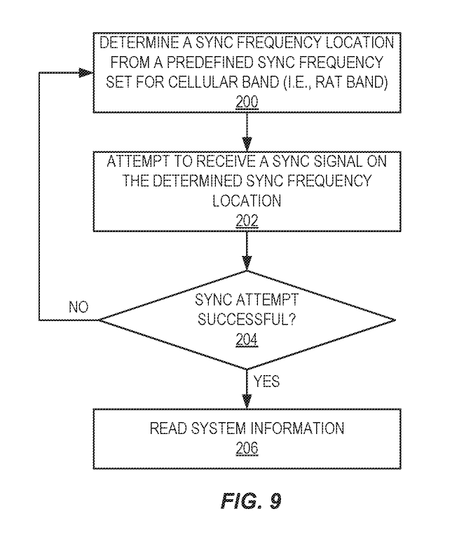

FIG. 9 presents a flow chart that illustrates a method of operation of a device (e.g., UE 16) according to some embodiments of the present disclosure. As illustrated, the device determines a sync frequency location upon which to attempt to synchronize from a predefined sync frequency set for the cellular band (step 200). As a separate step, the cellular band may be determined prior to step 200 (not shown).

Multiple options exist on how to determine the sync frequency location upon which to attempt to synchronize. In some embodiments, the sync frequency location may be determined by obtaining the sync frequency location from a predefined list or table of sync frequency locations in the sync frequency set. Thus, in this case, the device may read a table containing the set of sync frequency locations from memory. The device may alternatively retrieve the sync frequency location (or the sync frequency set) from a central node (e.g., a core network node) or derive the sync frequency location from a mathematical formula (e.g., that is predefined by, e.g., a standard) that defines the predefined sync frequency set. Furthermore, in some embodiments, the predefined sync frequency set may also be a function of which NR carrier spacing to use, i.e., different subcarrier spacings may have different allowed sync frequency locations (or sync signal bandwidths).

Once the sync frequency location is determined, the device attempts to receive a sync signal on the determined sync frequency location (step 202). This procedure is well known in the art and may include frequency error hypothesis testing in which the signal is first recorded and then digitally frequency modulated in order to account for a certain frequency error. For each frequency hypothesis, a filter matched to the sync signal is then applied where the sync may be identified as a peak in the filtering output. The device may then move on to identify further sync signals, e.g., secondary sync signals, to obtain more cell or beam information, also well known in the art. The device determines whether the sync attempt was successful (step 204). For example, in a manner to conventional LTE which uses Primary Synchronization Signal (PSS) and Secondary Synchronization Signal (SSS), the device may, in some embodiments, determine that the attempt is successful if a correlation between a received signal on the determined sync frequency location and a predefined sequence (e.g., PSS, SSS, or similar synchronization sequence) is higher than a predefined threshold. This correlation may be performed using matched filtering. Otherwise, the device determines that the attempt failed. If the sync attempt failed, the device returns to step 200 where the device determines a different sync frequency location from the sync frequency set and repeats the process for this new sync frequency location. The process repeats until the attempt to sync is successful. At that point, the device reads or accesses system information, e.g., in the conventional manner (step 206). Note that accessing the system information may also include a random access attempt and a corresponding random access reply in which the device may determine the Public Land Mobile Network (PLMN) and/or system information (e.g., carrier bandwidth).

The process of FIG. 9 is now described for one particular example in which a tree search algorithm is used. A tree search algorithm is one option for determining the sync frequency location from the predefined sync frequency set for the cellular band in step 200. Using the tree search algorithm, sync frequency locations in the sync frequency set are iteratively computed from a binary search tree that defines the sync frequency set until the sync attempt in step 202 is successful. So, for the first iteration of the process in FIG. 9, the device determines a first, or starting, sync frequency location in the binary search tree and (as discussed below) attempts to receive a sync signal on that sync frequency location. If the attempt fails, the device uses the binary search tree to obtain another sync frequency and repeats the process. This continues until sync is successful or the tree level exceeds a predefined and possibly band dependent index upon which the search stops.

Using LTE Band 7 at 2.6 GHz (2620-2690 MHz) with a bandwidth B=70 MHz as an example, the center frequency of that band may be used as an initial sync frequency, i.e., f(0)=2655 MHz. Hence, in the first iteration of the process, the device attempts to receive a sync on the sync frequency location having, in this example, the center frequency f(0) in step 202. This procedure is well known in the art and may include frequency error hypothesis testing in which the signal is first recorded and then digitally frequency modulated in order to account for a certain frequency error. For each frequency hypothesis, a filter matched to the sync signal is then applied where the sync may be identified as a peak in the filtering output. The device may then move on to identify further sync signals, e.g., secondary sync signals, to obtain more cell or beam information, also well known in the art.

If the sync attempt is successful (step 204; YES), the device continues by receiving system information (step 206). On the other hand, if no sync is identified at the determined sync frequency (step 204; NO), the search may continue iteratively on sync frequency locations in the sync frequency set according to the following iterative algorithm:

$$f ( k ) = [ \begin{matrix}f ( k - 1 ) - \frac{B}{{2}^{k + 1}} & f ( k - 1 ) + \frac{B}{{2}^{k + 1}}\end{matrix} ]$$

Here, the law of geometric sums assures that f(k) will remain within the cellular frequency band for all k>0. The index k represents the present level or depth of the search tree. The algorithm is executed by incrementing k until a sync frequency is identified, or until the value of k has reached a predefined maximum value. The selection order within each vector f(k) may be either sequentially or randomly, or according to another scheme, e.g., starting with the outermost frequencies in order to increase likelihood of finding a sync.

Note that, in the example above, the top-down approach is used (i.e., a binary search tree algorithm is used in which the sync frequency locations are computed as the binary search tree is searched). However, as described above, in some alternative embodiments, a fixed raster design may be used in which a binary search tree(s) is constructed from fixed sync frequency locations.

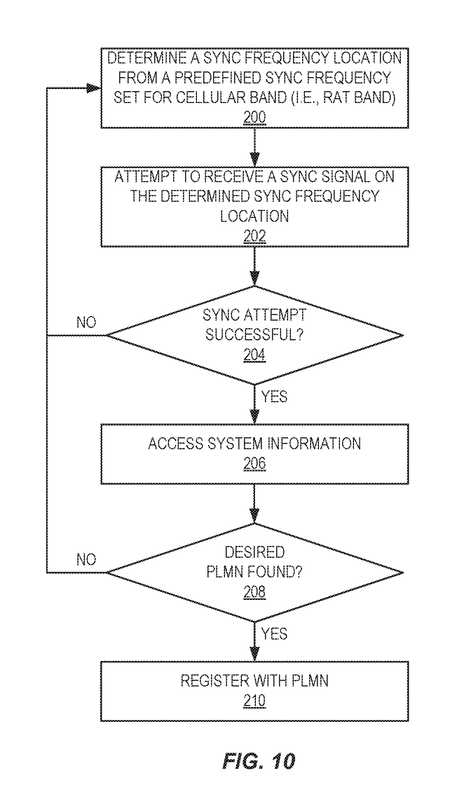

In an extended implementation, see FIG. 10, the device accesses the system information in step 206. Note that accessing the system information may also include random access attempt and a corresponding random access reply in which the device may determine the PLMN and/or system information (e.g., carrier bandwidth). The device may determine whether the identified PLMN is a desired PLMN, or not (step 208). The PLMN is determined by reading system information that may have been transmitted from the network in a master information block or in system information block (broadcast information). If the PLMN coincides with a home PLMN of the device or some other acceptable PLMN (for the device, defined by pre-configuration of the operator), then the PLMN is a “desired PLMN.” If not, the process continues with a new sync frequency location from the predefined sync frequency set, as described above. Conversely, if the identified PLMN is the desired PLMN, the device registers with the identified PLMN (step 210).

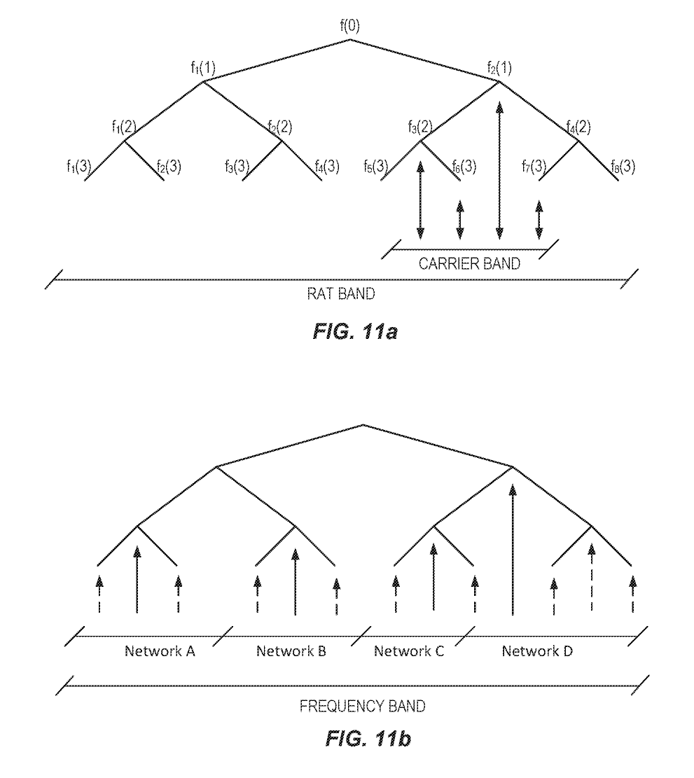

An illustration of sync allocation based on the tree search approach of step 200, presenting all sync frequency locations resulting from a four-level tree search, is shown in FIG. 11a. By starting a search at the center frequency location, the device may determine that the frequency location at f(0) does not contain any sync frequency, or the sync frequency location is for the wrong PLMN. Continuing with the first level of the iteration, the device computes the vector f(1) comprising the two elements f₁(1) and f₂(1) and searches these two in some order. Note that this iterative procedure doubles the elements for each iteration, providing a finer sync raster. Hence, the iteration should not take place each time sync is unsuccessful but only when all vector elements have been tested. With this design, the law of geometric ascertains that the sync frequency locations do not end up outside the frequency band. If the network node transmitting the sync signal has determined that selecting f₂(1) is preferable from a device perspective, provided the device utilizes the same search tree algorithm, the device may identify the sync frequency at f₂(1), resulting in an efficient search algorithm.

FIG. 11b illustrates an example of the search structure for a hierarchical, tree based sync search. Using LTE Band 1 at 2.1 GHz (2110-2170 MHz) DL with a bandwidth B, B=60 MHz, as an example, the center frequency of that band may be used as a sync starting frequency, i.e., f(0)=2140 MHz. In this example the frequency band is shared by four networks or systems: Network A (with a carrier band of 15 MHz), Network B (with a carrier band of 15 MHz 15 MHz), Network C (with a carrier band of 10 MHz) and Network D (with a carrier band of 20 MHz). Solid arrows illustrate more preferred sync frequency locations (i.e. higher hierarchical order or level in the tree) within a network band and dashed arrows illustrates less preferred sync frequency locations. FIG. 11b illustrates that, despite a suboptimal placement, all networks would be identified after only six sync attempts. This would allow for a guaranteed sync detection of 0.6 seconds with a sync period of 100 ms and minimal memory requirements since only a short segment of the band must be recorded at a time. If the UE is able to record the full bandwidth for the whole period, sync may be detected much faster than that.

The hierarchical, tree based sync deployment algorithms disclosed herein will allow for both sync location flexibility and fast sync speeds, irrespective of where in the frequency band the system bandwidth is located. Taking into account a desirable property that a few high probability sync locations distributed throughout the whole frequency band are defined together with many less probable sync locations also spread throughout the frequency band. Such a hierarchical, tree sync scheme would allow for both efficient sync detection for most bands as well as flexible sync locations together with low sync detection complexity.

Further embodiments of the present disclosure may involve selecting which table to use or which mathematical formula to use when computing the sync frequency location based on numerology (e.g. subcarrier spacing, symbol duration etc).

In addition to the above descriptions, the determined frequencies may be rounded, truncated, or similarly altered to its nearest EARFCN (or other future defined NR frequency channel number), as is well known in the art.

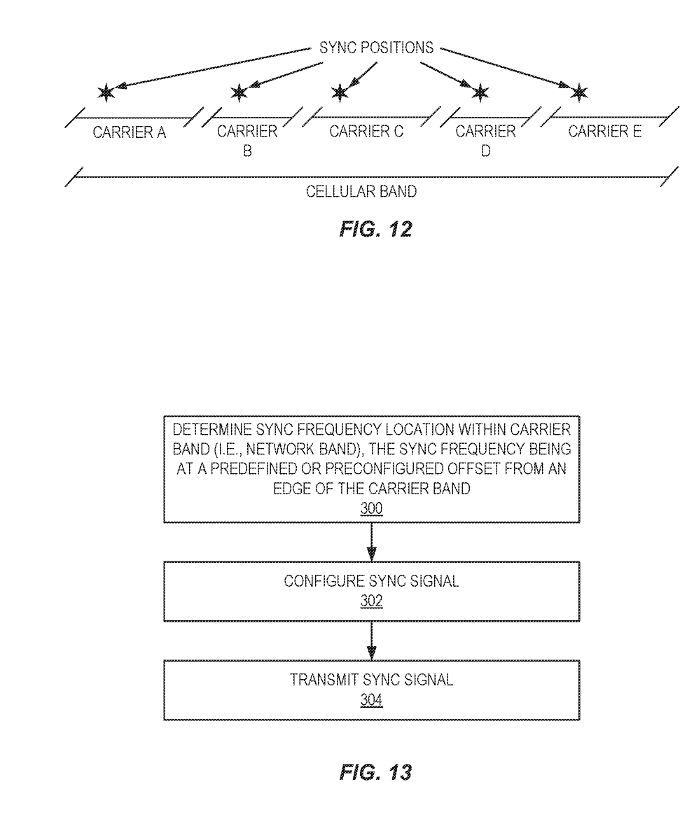

Further embodiments, relate to starting the search for a sync signal at an edge in the cellular band, i.e., for carriers located at the edge of the band. The scheme may also be based on the other edge or both edges, meeting in the middle of the frequency band. One example is illustrated in FIG. 12. As illustrated, multiple carrier bands (Carrier Bands A, B, C, D, and E) are implemented within the same cellular band. Further, for each carrier band, the respective sync frequency location is located at a predefined offset from an edge of that carrier band. The offset may be 0 or small (e.g., less than 1/10 the bandwidth of the cellular band). Further, the separation between adjacent carrier bands is predefined (e.g., fixed) such that, upon successfully detecting the sync signal for carrier band A (and possibly obtaining the respective system information), the device can determine the sync frequency location for carrier band B from the known bandwidth of carrier band A, the known separation between carrier band A and carrier band B, and the known offset of the sync frequency for carrier band B from the edge of carrier band B. Once the device successfully detects the sync signal for carrier band B, the device can then determine the sync frequency location for carrier band C, and so on.

FIG. 13 is a flow chart that illustrates the operation of a network node (e.g., a radio access node 14) according to some embodiments of the present disclosure. As illustrated, the network node determines a sync frequency location with the respective carrier band to use for transmitting sync signals (step 300). The determined sync frequency location is at a predefined or preconfigured offset from an edge of the carrier band. The network node then configures the sync signal (step 302) and transmits the sync signal on the determined sync frequency (step 304).

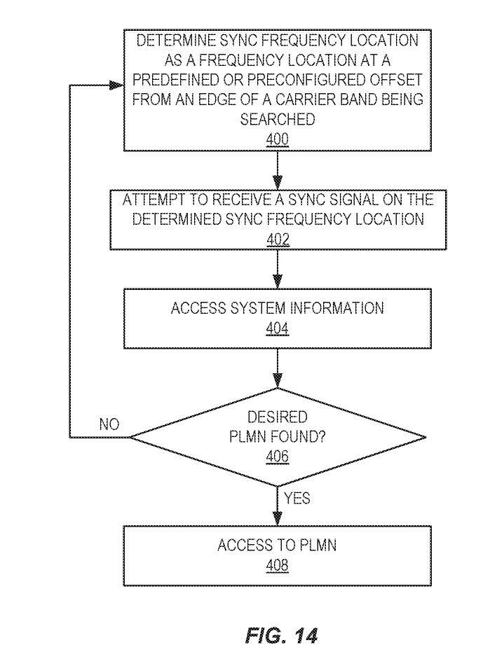

FIG. 14 is a flow chart that illustrates the operation of a wireless device (e.g., a UE 16) according to some embodiments of the present disclosure. As illustrated, the device determines a sync frequency location on which to attempt synchronization (step 400). The sync frequency location is at a predefined offset from the edge of the carrier band being searched. For the first iteration, the device may assume that the carrier band being searched has an edge that is offset from the edge of the cellular band by a predefined or preconfigured offset. The device attempts to receive a sync signal on the determined sync frequency location (step 402). Assuming that the attempt is successful, the device accesses the system information (step 404) and determines whether a desired PLMN has been found (step 406). The PLMN is determined by reading system information that may have been transmitted from the network in a master information block or in system information block (broadcast information). If the PLMN coincides with a home PLMN of the device or some other acceptable PLMN (for the device, defined by pre-configuration of the operator), then the PLMN is a “desired PLMN.” If not, the process returns to step 400 where the device determines the sync frequency location upon which to attempt synchronization for the next carrier band to search based on the known bandwidth of the carrier band just searched (which may be obtained from the system information), the known separation between adjacent carrier bands, and the known offset of the sync frequency from the edge of the carrier band. Conversely, if the desired PLMN is found, the device connects to the PLMN (step 408).

If an edge sync scheme is implemented, i.e., by positioning the sync frequency location at the edge of the carrier band (including a fixed distance from the edge of the carrier band), then the sync frequency location may be identified independently of the carrier bandwidth, i.e., one search would comprise, e.g., 20, 40, 60, 100 MHz carrier bandwidths within said frequency band, and greatly reducing the number of possible sync frequency locations within the band. Testing for a sync frequency location and receiving a sync signal (step 402) and, upon receiving system information (step 404) also determined the cell bandwidth and PLMN. If the PLMN was not the preferred PLMN (step 406; NO), the device may utilize the knowledge of the PLMN's bandwidth to identify a preferable sync frequency location for an adjacent PLMN (including a band gap between the two carriers), and then to attempt to receive a sync signal from the second one (step 400). In this way, the device may move sequentially from one end of the band to the middle (or end) of the band.

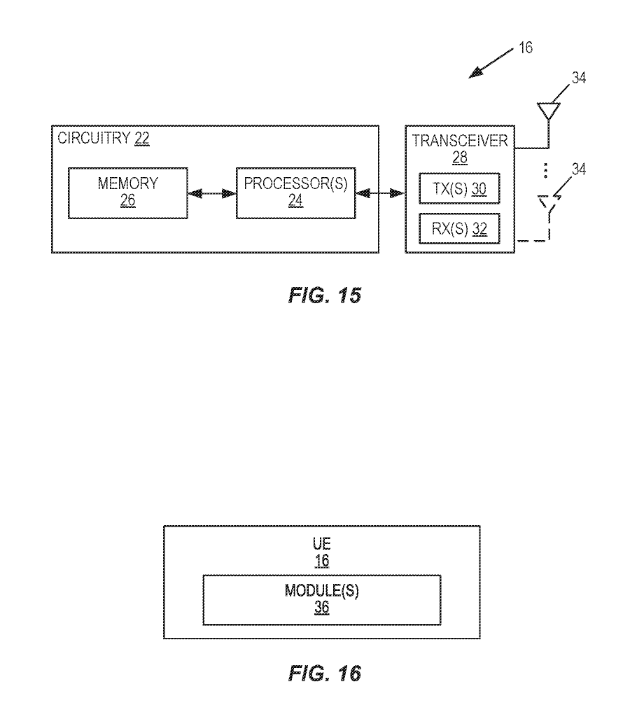

FIG. 15 is a schematic block diagram of the UE 16 (or more generally a wireless device) according to some embodiments of the present disclosure. As illustrated, the UE 16 includes circuitry 22 comprising one or more processors 24 (e.g., Central Processing Units (CPUs), Application Specific Integrated Circuits (ASICs), Field Programmable Gate Arrays (FPGAs), and/or the like) and memory 26. The UE 16 also includes one or more transceivers 28 each including one or more transmitter 30 and one or more receivers 32 coupled to one or more antennas 34. In some embodiments, the functionality of the UE 16 described above may be fully or partially implemented in software that is, e.g., stored in the memory 26 and executed by the processor(s) 24.

In some embodiments, a computer program including instructions which, when executed by at least one processor, causes the at least one processor to carry out the functionality of the UE 16 according to any of the embodiments described herein is provided. In some embodiments, a carrier containing the aforementioned computer program product is provided. The carrier is one of an electronic signal, an optical signal, a radio signal, or a computer readable storage medium (e.g., a non-transitory computer readable medium such as memory).

FIG. 16 is a schematic block diagram of the UE 16 (or more generally a wireless device) according to some other embodiments of the present disclosure. The UE 16 includes one or more modules 36, each of which is implemented in software. The module(s) 36 provide the functionality of the UE 16 described herein.

The module(s) 36 may comprise determining module(s), receive module(s), comparing module(s), read module(s), access module(s), and register module(s) adapted to perform the functions illustrated by FIG. 9, FIG. 10, and/or FIG. 14.

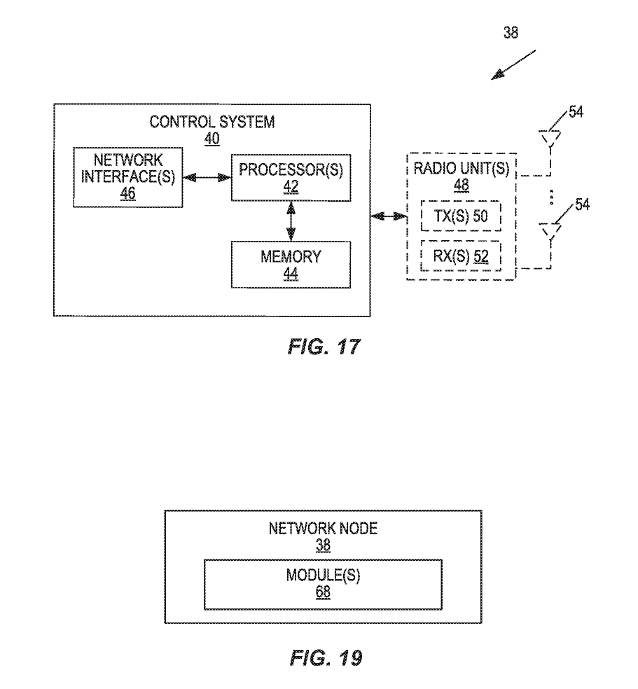

FIG. 17 is a schematic block diagram of a network node 38 (e.g., the radio access node 14) according to some embodiments of the present disclosure. As illustrated, the network node 38 includes a control system 40 that includes circuitry comprising one or more processors 42 (e.g., CPUs, ASICs, FPGAs, and/or the like) and memory 44. The control system 40 also includes a network interface 46. In embodiments in which the network node 38 is a radio access node 14, the network node 38 also includes one or more radio units 48 that each include one or more transmitters 50 and one or more receivers 52 coupled to one or more antennas 54. In some embodiments, the functionality of the network node 38 described above may be fully or partially implemented in software that is, e.g., stored in the memory 44 and executed by the processor(s) 42.

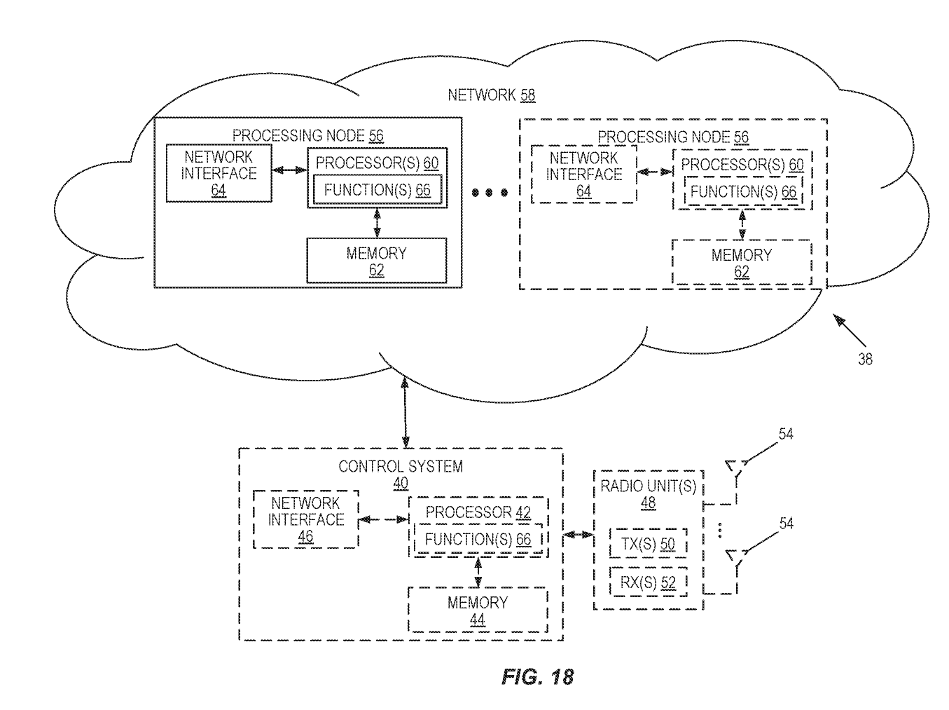

FIG. 18 is a schematic block diagram that illustrates a virtualized embodiment of the network node 38 (e.g., the radio access node 14) according to some embodiments of the present disclosure. As used herein, a “virtualized” network node 38 is a network node 38 in which at least a portion of the functionality of the network node 38 is implemented as a virtual component (e.g., via a virtual machine(s) executing on a physical processing node(s) in a network(s)). As illustrated, the network node 38 optionally includes the control system 40, as described with respect to FIG. 17. In addition, if the network node 38 is the radio access node 14, the network node 38 also includes the one or more radio units 48, as described with respect to FIG. 17. The control system 40 (if present) is connected to one or more processing nodes 56 coupled to or included as part of a network(s) 58 via the network interface 46. Alternatively, if the control system 40 is not present, the one or more radio units 48 (if present) are connected to the one or more processing nodes 56 via a network interface(s). Alternatively, all of the functionality of the network node 38 described herein may be implemented in the processing nodes 56 (i.e., the network node 38 does not include the control system 40 or the radio unit(s) 48). Each processing node 56 includes one or more processors 60 (e.g., CPUs, ASICs, FPGAs, and/or the like), memory 62, and a network interface 64.

In this example, functions 66 of the network node 38 described herein are implemented at the one or more processing nodes 56 or distributed across the control system 40 (if present) and the one or more processing nodes 56 in any desired manner. In some particular embodiments, some or all of the functions 66 of the network node 38 described herein are implemented as virtual components executed by one or more virtual machines implemented in a virtual environment(s) hosted by the processing node(s) 56. As will be appreciated by one of ordinary skill in the art, additional signaling or communication between the processing node(s) 56 and the control system 40 (if present) or alternatively the radio unit(s) 48 (if present) is used in order to carry out at least some of the desired functions. Notably, in some embodiments, the control system 40 may not be included, in which case the radio unit(s) 48 (if present) communicates directly with the processing node(s) 56 via an appropriate network interface(s).

In some embodiments, a computer program including instructions which, when executed by at least one processor, causes the at least one processor to carry out the functionality of the network node 38 or a processing node 56 according to any of the embodiments described herein is provided. In some embodiments, a carrier containing the aforementioned computer program product is provided. The carrier is one of an electronic signal, an optical signal, a radio signal, or a computer readable storage medium (e.g., a non-transitory computer readable medium such as memory).

FIG. 19 is a schematic block diagram of the network node 38 (e.g., the radio access node 14) according to some other embodiments of the present disclosure. The network node 38 includes one or more modules 68, each of which is implemented in software. The module(s) 68 provide the functionality of the network node 38 described herein.

The module(s) 38 may comprise obtaining module(s), determining module(s), configuring module(s), and transmit module(s) adapted to perform the functions illustrated by FIG. 5 and/or FIG. 13.

Those skilled in the art will recognize improvements and modifications to the embodiments of the present disclosure. All such improvements and modifications are considered within the scope of the concepts disclosed herein.

1. A method of a network node, operating in a carrier band within a cellular band, for distributing a sync signal, the method comprising the steps of:
determining, from a predefined sync frequency set for the cellular band, a sync frequency location that is within the carrier band, wherein the predefined sync frequency set comprising a plurality of sync frequency locations that are allowable for the cellular band;
configuring a sync signal to be transmitted on the determined sync frequency location; and
transmitting the sync signal on the determined sync frequency location.

2. The method of claim 1 wherein the predefined sync frequency set for the cellular band is predefined as a list of allowable sync frequency locations for the cellular band.

3. The method of claim 2 wherein the list is ordered in order of sync frequency location priority.

4. The method of claim 2 where the sync frequency locations for edge carrier bands are located at the first/last position in the list.

5. The method of claim 1 wherein the predefined sync frequency set is defined by a mathematical formula.

6. The method of claim 5 wherein the mathematical formula defines a binary search tree.

7. The method of claim 6 wherein determining the sync frequency location that is within the carrier band comprises searching the binary search tree to identify the sync frequency location that is within the carrier band.

8. The method of claim 6 wherein determining the sync frequency location comprises selecting the sync frequency location from a predefined level in the binary search tree.

9. The method of claim 1 wherein the predefined sync frequency set consists of a plurality of fixed sync frequency locations.

10. The method of claim 9 wherein determining the sync frequency location that is within the carrier band comprises:
constructing a binary search tree from the plurality of fixed sync frequency locations such that each fixed sync frequency location corresponds to a different node in the binary search tree; and
searching the binary search tree to find the sync frequency location on which to configure the sync signal to be transmitted.

11. The method of claim 10 wherein binary search tree spans a frequency band having a bandwidth that is greater than that of the cellular band.

12. The method of claim 9 wherein determining the sync frequency location that is within the carrier band comprises:
constructing a first binary search tree from a first subset of the plurality of fixed sync frequency locations such that each fixed sync frequency location in the first subset corresponds to a different node in the first binary search tree;
constructing a second binary search tree from a second subset of the plurality of fixed sync frequency locations such that each fixed sync frequency location in the second subset corresponds to a different node in second first binary search tree, wherein, together, the first subset and the second subset of the plurality of fixed sync frequency locations cover the cellular band; and
searching at least one of the first binary search tree and the second binary search tree to find the sync frequency location on which to configure the sync signal to be transmitted.

13. The method of claim 12 wherein first binary search tree spans a frequency band having a bandwidth that is less than that of the cellular band, and the second binary search tree spans a frequency band having a bandwidth that is less than that of the cellular band.

14. The method of claim 1 further comprising obtaining the predefined sync frequency set.

15. The method of claim 14 wherein obtaining the predefined sync frequency set comprises obtaining the predefined sync frequency set from a predefined list of sync frequency locations for the cellular band.

16. The method of claim 14 wherein obtaining the predefined sync frequency set comprises obtaining the predefined sync frequency set from a mathematical formula.

17. The method of claim 16 wherein results of the mathematical formula are rounded to the nearest Evolved Universal Terrestrial Radio Access, E-UTRA, Absolute Radio Frequency Channel Number, EARFCN.

18. The method of claim 14 where obtaining the predefined sync frequency set is dependent on a selected numerology for the carrier band.

19. The method of claim 1 wherein the predefined sync frequency set is a function of carrier spacing to use.

20. The method of claim 1 wherein the predefined sync frequency set comprises a sync frequency location that is at or near either a beginning or end of the carrier band.

21. The method of claim 1 wherein determining the sync frequency location comprises determining the sync frequency location based on User Equipment device, UE, capabilities (e.g., sync frequency location and/or number of sync frequency locations).

22. The method of claim 1 where configuring the sync signal comprises determining which resource elements to allocate for the sync signal.

23. (canceled)

24. A network node, operating in a carrier band within a cellular band, for distributing a sync signal, comprising:
at least one processor; and
memory comprising instructions executable by the at least one processor whereby the network node is operable to:
determine, from a predefined sync frequency set for the cellular band, a sync frequency location that is within the carrier band, wherein the predefined sync frequency set comprising a plurality of sync frequency locations that are allowable for the cellular band;
configure a sync signal to be transmitted on the determined sync frequency location; and
transmit the sync signal on the determined sync frequency location.

25. (canceled)

26. A method of a wireless communication device for performing synchronization to a wireless communications network, comprising:
determining a sync frequency location from a predefined sync frequency set for a cellular band, the cellular band comprising multiple carrier bands; and
attempting to receive a sync signal on the determined sync frequency.

27. The method of claim 26 further comprising:
determining whether attempting to receive a sync signal on the determined sync frequency location was successful; and
if attempting to receive a sync signal on the determined sync frequency location was not successful:
determining a new sync frequency location from the predefined sync frequency set for the cellular band; and
attempting to receive a sync signal on the new sync frequency location.

28. The method of claim 26 further comprising:
determining whether attempting to receive a sync signal on the determined sync frequency location was successful; and
if attempting to receive a sync signal on the determined sync frequency location was successful, reading system information transmitted on a respective cell or beam.

29. The method of claim 28 further comprising, if attempting to receive a sync signal on the determined sync frequency location was successful:
determining whether, as a result of the successful reception of a sync signal, a desired Public Land Mobile Network, PLMN, has been found; and
if the desired PLMN has not been found:
determining a new sync frequency location from the predefined sync frequency set for the cellular band; and
attempting to receive a sync signal on the new sync frequency location.

30. The method of claim 29 wherein determining the new sync frequency location comprises determining the new sync frequency location such that the new sync frequency location is not within a carrier bandwidth of a carrier associated with the determined sync frequency location.

31. The method of claim 28 further comprising, if attempting to receive a sync signal on the determined sync frequency location was successful:
determining whether, as a result of the successful reception of a sync signal, a desired Public Land Mobile Network, PLMN, has been found; and
if the desired PLMN has been found, connecting to the desired PLMN.

32. The method of claim 26 wherein determining the sync frequency location further comprises determining the cellular band.

33. The method of claim 26 wherein the predefined sync frequency set for the cellular band is predefined as a list of allowable sync frequency locations for the cellular band.

34. The method of claim 26 wherein determining the sync frequency location comprises prioritizing sync frequency locations in the predefined sync frequency set that are nearest to at least one of the edges of the cellular band.

35. The method of claim 26 wherein the predefined sync frequency set is defined by a mathematical formula.

36. The method of claim 35 wherein the mathematical formula defines a binary search tree.

37. The method of claim 36 wherein determining the sync frequency location comprises obtaining the sync frequency location from the binary search tree.

38. The method of claim 36 wherein determining the sync frequency location comprises selecting the sync frequency location from a predefined level in binary search tree.

39. The method of claim 35 wherein results of the mathematical formula are rounded to the nearest Evolved Universal Terrestrial Radio Access, E-UTRA, Absolute Radio Frequency Channel Number, EARFCN.

40. The method of claim 26 wherein the predefined sync frequency set consists of a plurality of fixed sync frequency locations.

41. The method of claim 40 wherein determining the sync frequency location that is within the carrier band comprises:
constructing a binary search tree from a plurality of potential sync frequency locations comprising the plurality of fixed sync frequency locations such that each potential sync frequency location corresponds to a different node in the binary search tree; and
searching the binary search tree to find the sync frequency location on which to attempt to detect the sync signal.

42. The method of claim 41 wherein binary search tree spans a frequency band having a bandwidth that is greater than that of the cellular band.

43. The method of claim 26 wherein determining the sync frequency location that is within the carrier band comprises:
constructing a first binary search tree from a first subset of the plurality of fixed sync frequency locations such that each fixed sync frequency location in the first subset corresponds to a different node in the first binary search tree;
constructing a second binary search tree from a second subset of the plurality of fixed sync frequency locations such that each fixed sync frequency location in the second subset corresponds to a different node in second binary search tree; and
searching at least one of the first binary search tree and the second binary search tree to find the sync frequency location on which to attempt to detect the sync signal.

44. The method of claim 43 wherein first binary search tree spans a frequency band having a bandwidth that is less than that of the cellular band, and the second binary search tree spans a frequency band having a bandwidth that is less than that of the cellular band.

45. The method of claim 26 wherein the predefined sync frequency set is a function of carrier spacing to use.

46. The method of claim 26 wherein the predefined sync frequency set comprises, for each of a plurality of carrier bands implemented within the cellular band, a sync frequency location that is at or near either a beginning or end of the carrier band.

47. The method of claim 26 wherein determining the sync frequency location comprises determining the sync frequency location based on capabilities of the wireless communication device (e.g., sync frequency location and/or number of sync frequency locations).

48. (canceled)

49. A wireless communication device for performing synchronization to a wireless communications network, the wireless communication device comprising:
at least one processor; and
memory comprising instructions executable by the at least one processor whereby the wireless communication device is operable to:
determine a sync frequency location from a predefined sync frequency set for a cellular band, the cellular band comprising multiple carrier bands; and
attempt to receive a sync signal on the determined sync frequency.

50. (canceled)
